(19) United States
(12) Patent Application Publication
(10) Pub. No.: US 2026/0184949 A1
(43) Pub. Date: Jul. 2, 2026

(54) AQUEOUS POLYMER DISPERSION AND COATING COMPOSITION

(71) Applicant: DOW GLOBAL TECHNOLOGIES LLC, MIDLAND, MI (US)

(72) Inventors: Yaguang ZHAO, Shanghai (CN); Zhen QIAN, Shanghai (CN); Jianming XU, Shanghai (CN); Wei CUI, Shanghai (CN); Longlan CUI, Shanghai (CN)

(21) Appl. No.: 19/130,793

(22) PCT Filed: Dec. 30, 2022
(86) PCT No.: PCT/CN2022/143786

§ 371 Date: May 16, 2025

(51) Int. Cl. C09D 133/06; C08F 220/18; C08F 222/14; C09D 5/02; C09D 7/63; C09D 7/65; C09D 135/02

(52) U.S. Cl. CPC C09D 133/064; C08F 220/1802; C08F 222/14; C09D 5/022; C09D 7/63; C09D 7/65; C09D 135/02; C08F 2800/20

(57) ABSTRACT

An aqueous dispersion contains an emulsion polymer of particle size of 60-300 nanometers. The emulsion polymer is the polymerized product of: (a) 24.5-35 wt % of monomer having a biobased carbon content of 92% or more and having formula (I); (b) 0.1-10 wt % of a ethylenically unsaturated monomer carrying at least one functional group; (c) 20-50 wt % of ethyl (meth)acrylate that has a biobased carbon content of 30% to 60%; (d) 4-20 wt % of structural units of an alkyl (meth)acrylate that has a linear alky group with 8 to 16 carbon atoms and that has a biobased carbon content of 60% or more; (e) 1.5-7 wt % of an acetoacetoxy or acetoacetamide functional monomer; (f) 5-25 wt % of a hard monomer; and (g) 0-15 wt % of an additional ethylenically unsaturated nonionic monomer. The total concentration of structural units of monomers (c)-(f) is in a range of 51-74%. The aqueous dispersion can be used in a coating composition.

### FIELD

The present invention relates to an aqueous polymer dispersion suitable for use as a biobased binder and a coating composition comprising the same with balanced properties.

### INTRODUCTION

Aqueous or waterborne polymer binders are becoming increasingly more important than solvent-based binders in the coating industry for less environmental problems. The coating industry is always interested in developing coating compositions without or with substantially reduced volatile organic compound (VOC) content, for example, not greater than 10 grams (g) of VOCs per liter of coating compositions. To achieve such zero- or low-VOC requirement, waterborne polymer binders are often designed to be rather soft by reducing glass transition temperatures to ensure good film formation properties when the amount of coalescents added in coating compositions is reduced or eliminated. However, using these soft polymer binders in coating compositions usually hurts scrub resistance, peel-off resistance, and early chalking resistance properties of coating films made therefrom. Freeze/thaw stability of formulated coating compositions is also compromised due to the removal of volatile anti-freeze agents such as propylene glycerol and ethyl glycerol. Meanwhile, paint formulators normally require binder films with resistance to water whitening. Incorporation of sufficient amounts of specific hydrophobic monomers into polymerization, such as greater than 20% by weight of octadecyl methacrylate relative to total monomers weight, may deliver binders with better water whitening resistance. However, due to the low solubility of these hydrophobic monomers in water, such approach usually causes large amount of coagulum (also as “gel”) (e.g., at a concentration of >500 parts of coagulum per million of a binder weight) formed in the resulting binders when emulsion polymerization is used. Thus, development of waterborne polymer binders with minimized coagulum content that are suitable for zero- or low-VOC coating compositions and that also afford balanced properties in scrub resistance, early chalking resistance, peel-off resistance, freeze-thaw stability, and water whitening resistance remains challenging.

It is further desirable to use renewable materials to replace fossil materials. For example, the United States Department of Agriculture (USDA) BioPreferred program requires minimum biobased carbon content (BCC) of 22% for biobased binders in the category of Intermediates-Paint and Coating Components, as determined according to ASTM D6866-22, and further increasing the BCC is desired by the market. However, it is challenging for aqueous coating compositions comprising biobased binders with a high BCC of above 40% to achieve coating properties that are comparable to conventional aqueous coatings.

Therefore, there remains a need to develop an aqueous polymer dispersion suitable for use as a biobased binder in coating compositions while still providing the above balanced properties.

### SUMMARY

The present invention provides a novel aqueous dispersion comprising an emulsion polymer particularly useful as a biobased binder for coating applications. Such aqueous dispersion can achieve improved balance in properties including water whitening resistance, and freeze-thaw stability, peel-off resistance, scrub resistance, and early chalking resistance of coatings made therefrom. In the meanwhile, the emulsion polymer of the present invention can achieve a biobased carbon content of greater than 40%, and desirably, 50% or more, as measured according to ASTM D6866-22 or calculated according to the Biobased Carbon Content Calculated Method described in the Examples section below. A coating composition comprising such aqueous dispersion can achieve zero or low VOCs, that is, 10 g/L VOCs or less, as measured according to GB18582-2008.

In a first aspect, the present invention is an aqueous dispersion comprising an emulsion polymer, wherein the emulsion polymer comprises, by weight based on the weight of the emulsion polymer,
(i) from 24.5% to 35% of structural units of monomer (a) having a biobased carbon content of 92% or more and having the structure of formula (I):

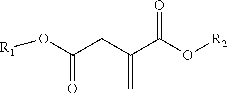

where R₁ and R₂ are each independently selected from an alkyl group having from 4 to 10 carbon atoms;
(ii) from 0.1% to 10% of structural units of monomer (b) an ethylenically unsaturated carrying at least one functional group selected from carboxyl, carboxylic anhydride, sulfonic acid, sulphonate, hydroxyl, amide, or combinations thereof; salts thereof; or mixtures thereof;
(iii) from 20% to 50% of structural units of monomer (c) ethyl (meth)acrylate that has a biobased carbon content of 30% to 60%;
(iv) from 4% to 20% of structural units of monomer (d) an alkyl (meth)acrylate that has a linear alky group with 8 to 16 carbon atoms and that has a biobased carbon content of 60% or more;
(v) from 1.5% to 7% of structural units of monomer (e) an acetoacetoxy or acetoacetamide functional monomer;
(vi) from 5% to 25% structural units of monomer (f) a hard monomer; and
(vii) from zero to 15% of structural units of monomer (g) an additional ethylenically unsaturated nonionic monomer;
wherein the total concentration of structural units of monomers (c), (d), (e), and (f) is in a range of from 51% to 74%; and
wherein the emulsion polymer particles have a particle size of 60 nanometers to 300 nanometers.

In a second aspect, the present invention is a method of preparing the aqueous dispersion of the first aspect. The method comprises emulsion polymerization of monomers comprising monomers (a) to (g).

In a third aspect, the present invention is a coating composition comprising the aqueous dispersion of the first aspect.

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods, GB refers to national standard of P. R. China, and ISO refers to International Organization for Standards.

Products identified by their tradename refer to the compositions available under those tradenames on the priority date of this document. “And/or” means “and, or as an alternative”. All ranges include endpoints unless otherwise indicated.

“Aqueous” dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, or mixtures thereof. “Structural units”, also known as “polymerized units”, of the named monomer, refers to the remnant of the monomer after polymerization, that is, polymerized monomer or the monomer in polymerized form. For example, a structural unit of methyl methacrylate is as illustrated:

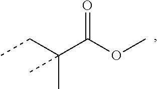

where the dotted lines represent the points of attachment of the structural unit to the polymer backbone.

Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

“Glass transition temperature” or “T_{g}” can be measured by various techniques including, for example, differential scanning calorimetry (“DSC”) or calculation by using a Fox equation. The particular values of T_{g} reported herein are those calculated by using a Fox equation (T. G. Fox, Bull. Am. Physics Soc., Volume 1, Issue No. 3, page 123 (1956)) below. For example, for calculating the T_{g} of a copolymer of monomers M₁ and M₂.

$$\frac{1}{{T}_{g} ( calc )} = \frac{w ( {M}_{1} )}{{T}_{g} ( {M}_{1} )} + \frac{w ( {M}_{2} )}{{T}_{g} ( {M}_{2} )}$$

where T_{g}(calc.) is the glass transition temperature calculated for the copolymer, w(M₁) is the weight fraction of monomer M₁ in the copolymer, w(M₂) is the weight fraction of monomer M₂ in the copolymer, T_{g}(M₁) is the glass transition temperature of the homopolymer of monomer M₁, and T_{g}(M₂) is the glass transition temperature of the homopolymer of monomer M₂, all temperatures being in K. The glass transition temperatures of the homopolymers may be found, for example, in “Polymer Handbook”, edited by J. Brandrup and E. H. Immergut, Interscience Publishers.

Biobased carbon content of a monomer in the present invention is measured according to ASTM D6866-22 Standard Test Methods for Determining the Biobased Carbon Content of Solid, Liquid, and Gaseous Samples Using Radiocarbon Analysis, unless otherwise stated.

The aqueous dispersion of the present invention comprises an emulsion polymer. The emulsion polymer comprises structural units of monomer (a) having the structure of formula (I):

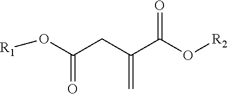

where R₁ and R₂ are each independently selected from an alkyl group having from 4 to 10 carbon atoms. The alkyl group for R₁ and R₂ each independently may have 4 to 8 carbon atoms or 4 to 6 carbon atoms, and desirably 4 carbon atoms.

The monomer (a) useful in the present invention can be a mixture of two or more monomers of formula (I) that are different in R₁ and/or R₂. The monomer (a) may have a biobased carbon content of 92% or more, and can be 92% or more, 95% or more, 97% or more, 99% or more, or even 100%. When monomer (a) is a combination of more than one monomer of formula (I) then the BCC is the combined BCC of these monomers of formula (I). Specific examples of monomer (a) include dibutyl itaconate (DBI), dihexyl itaconate, dioctyl itaconate, didecanyl itaconate, or mixtures thereof. Desirably, monomer (a) is dibutyl itaconate.

The emulsion polymer may comprise structural units of monomer (a) at a concentration of 24.5% to 35%, and can be 24.5% or more, 25% or more, 26% or more, 27% or more, 28% or more, 29% or more, even 30% or more while at the same time is 35% or less, and can be 34% or less, 33% or less, 32% or less, 31% or less, or even 30% or less, and desirably, from 25% to 34% or from 28% to 32%, by weight based on the weight of the emulsion polymer. “Weight of the emulsion polymer” in the present invention refers to the dry weight of the emulsion polymer.

The emulsion polymer useful in the present invention comprises structural units of monomer (b) an ethylenically unsaturated functional monomer carrying at least one functional group selected from carboxyl, carboxylic anhydride, sulfonic acid, sulphonate, hydroxyl, amide, ureido, or combinations thereof; salts thereof; or mixtures thereof. A combination of two or more different ethylenically unsaturated functional monomers can be used. Suitable ethylenically unsaturated functional monomers and salts thereof may include, for example, α, β-ethylenically unsaturated carboxylic acids including an acid-bearing monomer such as methacrylic acid (MAA), acrylic acid (AA), itaconic acid (IA), maleic acid, and fumaric acid; and a monomer bearing an acid-forming group which yields or is subsequently convertible to, such an acid group (e.g., anhydride, (meth)acrylic anhydride, or maleic anhydride); sodium styrene sulfonate (SSS), sodium vinyl sulfonate (SVS), 2-acrylamido-2-methylpropanesulfonic acid (AMPS), ammonium salt of 2-acrylamido-2-methyl-1-propane sulfonic acid, sodium salt of allyl ether sulfonate; hydroxy-functional alkyl (meth)acrylates such as hydroxyethyl (meth)acrylate, hydroxypropyl (meth)acrylate, and mixtures thereof; (meth)acrylamide; ureido-functional monomers such as N-(2-methacrylamidoethyl)ethylene urea and N-(2-methacryloyloxyethyl) ethylene urea; or mixtures thereof. Desirably, the ethylenically unsaturated functional monomer and salt thereof comprise or consist of methacrylic acid, acrylic acid, sodium styrene sulfonate, 2-acrylamido-2-methylpropanesulfonic acid, or mixtures thereof, and more desirably, methacrylic acid and sodium styrene sulfonate.

The emulsion polymer useful in the present invention may comprise structural units of the ethylenically unsaturated functional monomer and/or salt thereof at a concentration of from 0.1% to 10%, and can be 0.1% or more, 0.5% or more, 0.8% or more, 1% or more, 1.0% or more, even greater than 1.0% while at the same time is 10% or less, and can be 9% or less, 8% or less, 5% or less, 4% or less, 3% or less, 2.5% or less, 2% or less, or even 1.5% or less, and desirably, from 0.5% to 3% or from 0.8% to 2%, by weight based on the weight of the emulsion polymer.

The emulsion polymer useful in the present invention comprises structural units of monomer (c) ethyl (meth)acrylate, such as ethyl acrylate (EA), ethyl methacrylate, or mixtures thereof. Ethyl (meth)acrylate may have a biobased carbon content of 30% to 60%, which is typically formed from reacting (meth)acrylic acid with biobased alcohols such as biobased ethanol. The emulsion polymer may comprise, by weight based on the weight of the emulsion polymer, structural units of ethyl (meth)acrylate at a concentration of 20% to 50%, and can be 20% or more, 25% or more, 25.5% or more, 30% or more, 35% or more, 40% or more, 40.5% or more, 41% or more, 41.5% or more, 42% or more, 45% or more, even 46% or more while at the same time is 50% or less, and can be 49% or less, 48.5% or less, 48% or less, 47.5% or less, 46% or less, 45% or less, 44% or less, 43% or less, 42% or less, 41.5% or less, 41% or less, or even 40.5% or less, and desirably, from 35% to 50% or from 40% to 50%.

The emulsion polymer useful in the present invention comprises structural units of monomer (d) an alkyl (meth)acrylate that has a linear alkyl group with 8 to 16 carbon atoms (hereinafter also referred to as “long-chain alkyl (meth)acrylate”). The long-chain alkyl (meth)acrylate may have a biobased carbon content of at least 60%. The monomer (d) can be a mixture of two or more long-chain alkyl (meth)acrylates with different alkyl groups. When the long-chain alkyl (meth)acrylate is a combination of more than one long-chain alkyl (meth)acrylate then the BCC is the combined biobased carbon content of long-chain alkyl (meth)acrylates. Examples of suitable long-chain alkyl (meth)acrylates include n-octyl (meth)acrylate, n-decyl (meth)acrylate, lauryl (meth)acrylate, tetradecyl (meth)acrylate, hexadecyl (meth)acrylate, or mixtures thereof. Desirably, the long-chain alkyl (meth)acylate is lauryl methacrylate, tetradecyl methacrylate, hexadecyl methacrylate, or mixtures thereof. The emulsion polymer may comprise, by weight based on the weight of the emulsion polymer, structural units of the long-chain alkyl (meth)acrylate at a concentration of from 4% to 20%, and can be 4% or more, 4.5% or more, 5% or more, 5.5% or more, 6% or more, 6.5% or more, 7% or more, 7.5% or more, 8% or more, 8.5% or more, 9% or more, 9.5% or more, even 10% or more while at the same time is 20% or less, and can be 18% or less, 16% or less, 15% or less, 12% or less, or even 10% or less, and desirably, from 4% to 10%.

The emulsion polymer useful in the present invention may comprise structural units of monomer (e) an acetoacetoxy or acetoacetamide functional monomer. Monomer (e) can be a mixture of two or more different acetoacetoxy or acetoacetamide functional monomers. The acetoacetoxy or acetoacetamide functional monomer can be an ethylenically unsaturated acetoacetoxy or acetoacetamide functional monomer. The acetoacetoxy or acetoacetamide functional monomer can be a monomer having one or more acetoacetyl functional groups represented by:

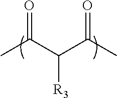

wherein R₃ is hydrogen, an alkyl having 1 to 10 carbon atoms, or phenyl.

The acetoacetoxy or acetoacetamide functional groups may include:

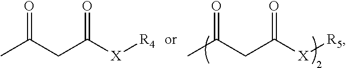

wherein X is O or N, R₄ is a divalent radical and R₅ is a trivalent radical, that attach the acetoacetoxy or acetoacetamide functional group to the backbone of the polymer.

Examples of suitable acetoacetoxy or acetoacetamide functional monomers include acetoacetoxyalkyl (meth)acrylates such as acetoacetoxyethyl methacrylate (AAEM), acetoacetoxyethyl acrylate, acetoacetoxypropyl methacrylate, acetoacetoxybutyl methacrylate, and 2,3-di(acetoacetoxy)propyl methacrylate; allyl acetoacetate; vinyl acetoacetate; acetoacetamidoalkyl (meth)acrylates such as acetoacetamidoethyl methacrylate, acetoacetamidoethyl acrylate; or combinations thereof. Desirably, the acetoacetoxy or acetoacetamide functional monomer is AAEM. The emulsion polymer may comprise, by weight based on the weight of the emulsion polymer, structural units of the acetoacetoxy or acetoacetamide functional monomer at a concentration of 1.5% to 7%, and can be 1.5% or more, 2% or more, 2.2% or more, 2.5% or more, 2.7% or more, even 3.0% or more while at the same time is 7% or less, and can be 6% or less, 5% or less, 4.5% or less, 4.2% or less, 4% or less, 3.8% or less, 3.5% or less, 3.2% or less, or even 3.0% or less, and desirably, from 2% to 4% or from 2.5% to 3.5%.

The emulsion polymer useful in the present invention may comprise structural units of monomer (f) a hard monomer. As used herein, the term “hard monomers” refers to a monomer whose homopolymer has a Fox Tg equal to or greater than 70° C. Suitable hard monomers may include, for example, a hard acrylic monomer such as methyl methacrylate (MMA), cycloalkyl (meth)acrylate such as cyclohexyl methacrylate, or mixtures thereof; styrene and substituted styrene such as alpha-methylstyrene, 2,4-dimethylstyrene, ethylstyrene, and butylstryene; and o-, m-, and p-methoxystyrene; (meth)acrylonitrile; or mixtures thereof. The monomer (f) can be a mixture of two or more different hard monomers. Desirably, the hard monomer includes or consists of methyl methacrylate. The emulsion polymer may comprise, by weight based on the emulsion polymer weight, structural units of the hard monomer at a concentration of from 5% to 25%, and can be 5% or more, 7% or more, 9% or more, 10% or more, 11% or more, even 12% or more while at the same times is generally 25% or less, and can be 20% or less, 18% or less, 16% or less, 15% or less, or even 14% or less. The emulsion polymer can be a pure acrylic polymer. Alternatively, the emulsion polymer may comprise less than 20%, less than 10%, or less than 5%, of structural units of styrene and/or substituted styrene, by weight based on the emulsion polymer weight. Desirably, the emulsion polymer is substantially free of structural units of styrene and/or substituted styrene, e.g., less than 1%, less than 0.5%, or even less than 0.1%, by weight based on the emulsion polymer weight.

The emulsion polymer useful in the present invention may comprise or be free of structural units of monomer (g) an additional ethylenically unsaturated nonionic monomer other than the monomers (a) to (f) described above. “Nonionic monomers” herein refers to monomers that do not bear an ionic charge between pH=1-14. The monomer (g) typically has a biobased carbon content in a range of from zero to 5%. The monomer (g) may be a mixture of two or more different additional ethylenically unsaturated nonionic monomers. Suitable additional ethylenically unsaturated nonionic monomers may include, for example, a monoethylenically unsaturated monomer such as butyl acrylate, butyl methacrylate, 2-ethylhexyl acrylate, or mixtures thereof; a multiethylenically unsaturated monomer such as butadiene, allyl (meth)acrylate, divinyl benzene, ethylene glycol dimethacrylate, butylene glycol dimethacrylate, and mixtures thereof; or mixtures thereof. The emulsion polymer may comprise or be free of structural units of the multiethylenically unsaturated monomer, typically at a concentration of zero to 1%, 0.05% to 0.8%, or 0.1% to 0.5%, and desirably, less than 0.5%, less than 0.1%, or even less than 0.05%, by weight based on the weight of the emulsion polymer. The emulsion polymer may comprise structural units of the additional ethylenically unsaturated nonionic monomer at a total concentration of zero to 15%, and can be 15% or less, 10% or less, 5% or less, or even 1% or less, by weight based on the weight of the emulsion polymer.

The emulsion polymer may comprise a minor amount of or be free of structural units of monomer (h) an itaconate diester other than the monomer (a) of formula (I). Monomer (h) may include dipropyl itaconate (DPI), diethyl itaconate (DEI), dimethyl itaconate (DMI), or mixtures thereof. The structural units of monomer (h) may be present at a concentration of less than 5%, and can be less than 4%, less than 3%, less than 2%, less than 1%, less than 0.01%, or even zero, by weight based on the weight of the emulsion polymer. Desirably, the emulsion polymer is substantially free of structural units of the itaconate diester other than monomer (a), less than 1%, less than 0.5%, less than 0.1%, less than 0.01%, or even zero by weight based on the weight of the emulsion polymer.

The total concentration of structural units of monomers (c), (d), (e), and (f) described above (i.e., ethyl (meth)acrylate, the long-chain alkyl (meth)acrylate, the acetoacetoxy or acetoacetamide functional monomer, and the hard monomer (desirably, the hard acrylic monomer)) may be in a range of from 51% to 74%, and can be 51% or more, 52% or more, 54% or more, 55% or more, 56% or more, 58% or more, 60% or more, 62% or more, 63.5% or more, 64% or more, 65% or more, 65%, 66% or more, 67.5% or more, 68% or more, even 68.5% or more while at the same time is 74% or less, and can be 73% or less, 72% or less, 71% or less, 70% or less, 69.5% or less, 69% or less, or even 68.5% or less, and desirably, 63.5% to 74% or 65% to 69%, by weight based on the weight of the emulsion polymer.

The total concentration of structural units of monomers (a) to (g) described above, if present, can be 100% by weight relative to the emulsion polymer weight. Types and amounts of the monomers described above for preparing the emulsion polymer may be chosen to provide the emulsion polymer with a glass transition temperature (Tg) in a range of −40 degrees Celsius (° C.) to 40° C., and can be −40° C. or more, −35° C. or more, −25° C. or more, −15° C. or more, even −10° C. or more while at the same time is 40° C. or less, and can be 35° C. or less, 20° C. or less, 15° C. or less, 10° C. or less, 0° C. or less, or even less than 0° C. Tg of the emulsion polymers may be calculated by using the Fox equation described above.

Desirably, the emulsion polymer comprises, by weight based on the weight of the emulsion polymer,
from 24.5% to 35% of structural units of dibutyl itaconate,
from 25.5% to 48.5% of structural units of ethyl acrylate,
from 0.5% to 5% of structural units of MAA, SSS, AMPS, or mixtures thereof;
from 4% to 20% of structural units of lauryl methacrylate, tetradecyl methacrylate, hexadecyl methacrylate, or mixtures thereof;
from 2% to 5% of structural units of acetoacetoxyethyl methacrylate,
from 5% to 20% of structural units of the hard monomer such as the hard acrylic monomer, and
from zero to 5% of structural units of the additional ethylenically unsaturated nonionic monomer.

The emulsion polymer can be a one-stage or multistage emulsion polymer. Desirably, the emulsion polymer is a multistage emulsion polymer which can provide even better early chalking resistance than one-stage emulsion polymer. The multistage emulsion polymer can be prepared by multistage emulsion polymerization. The multistage emulsion polymer may comprise a polymer A and a polymer B formed in at least two stages of the multistage polymerization, e.g., the first stage and the second stage. The polymer A and the polymer B have different compositions. The polymer A comprises or is free of structural units of monomer (e) the acetoacetoxy or acetoacetamide functional monomer and the polymer B comprises structural units of monomer (e). Desirably, the polymer A comprises, by weight based on the weight of the polymer A, from zero to 5%, and desirably, zero to less than 0.1%, of structural units of monomer (e) such as AAEM; and the polymer B comprises from 3.5% to 10% of structural units of monomer (e) such as AAEM, by weight based on the weight of the polymer B. Structural units of other monomers in the polymer A and the polymer B may be present in an amount so that the total concentration for structural units of each monomer in the multistage emulsion polymer is as described in the emulsion polymer above.

The polymer A and/or the polymer B of the multistage polymer may each independently comprise structural units of monomer (a) of formula (I). Monomer (a) is as described above, and desirably, DBI. The polymer A may comprise, by weight based on the weight of the polymer A, structural units of monomer (a) at a concentration of from 25% to 37%, and can be 25% or more, 25.3% or more, 26% or more, 27% or more, 28% or more, 29% or more, 30% or more, 31% or more, even 33% or more while at the same time is 37% or less, and can be 36.5% or less, 36.1% or less, 36% or less, 34% or less, 32% or less, or even 30% or less. The polymer B may comprise, by weight based on the weight of the polymer B, structural units of monomer (a) at a concentration of from 23% to 34%, and can be 23% or more, 23.5% or more, 23.8% or more, 25% or more, 27% or more, 29% or more, even 30% or more while at the same time is 34% or less, and can be 32% or less, 30% or less, 28% or less, or even 26% or less.

The polymer A and/or the polymer B of the multistage polymer may each independently comprise structural units of monomer (b) the ethylenically unsaturated functional monomer. Monomer (b) is as described above, and desirably, MAA, SSS, AMPS, or mixtures thereof. The polymer A may comprise, by weight based on the weight of the polymer A, structural units of monomer (b) at a concentration of from 0.5% to 5.5%, and can be 0.5% or more, 0.7% or more, 1.0% or more, 1.5% or more, even 2.5% or more while at the same time is 5.5% or less, and can be 4.5% or less, 3.5% or less, 2.5% or less, or even 1.5% or less. The polymer B may comprise, by weight based on the weight of the polymer B, structural units of monomer (b) at a concentration of from 0.5% to 5%, and can be 0.5% or more, 1% or more, 1.5% or more, 2% or more, even 2.5% or more while at the same time is 5% or less, and can be 4.5% or less, 3% or less, 3.5% or less, or even 2.5% or less.

The polymer A and/or the polymer B of the multistage polymer may each independently comprise structural units of monomer (c) ethyl (meth)acrylate. Monomer (c) is as described above, and desirably, EA. The polymer A may comprise, by weight based on the weight of the polymer A, structural units of monomer (c) at a concentration of from 26% to 50%, and can be 26% or more, 28% or more, 30% or more, 32% or more, even 35% or more while at the same time is 50% or less, and can be 45% or less, 40% or less, 35% or less, or even 30% or less. The polymer B may comprise, by weight based on the weight of the polymer B, structural units of monomer (c) at a concentration of from 24% to 48%, and can be 24% or more, 26% or more, 28% or more, 30% or more, even 35% or more while at the same time is 48% or less, and can be 45% or less, 40% or less, 35% or less, or even 30% or less.

The polymer A and/or the polymer B of the multistage polymer may each independently comprise structural units of monomer (d) the long-chain alkyl (meth)acrylate. Monomer (d) is as described above, and desirably, monomer (d) is selected from lauryl methacrylate, tetradecyl methacrylate, hexadecyl methacrylate, or mixtures thereof. The polymer A may comprise, by weight based on the weight of the polymer A, structural units of monomer (d) at a concentration of from 4% to 21%, and can be 4% or more, 4.1% or more, 5% or more, 7% or more, 9% or more, even 11% or more while at the same time is 21% or less, and can be 20.6% or less, 20% or less, 18% or less, 16% or less, 14% or less, or even 12% or less. The polymer B may comprise, by weight based on the weight of the polymer B, structural units of monomer (d) at a concentration of from 3.5% to 20%, and can be 3.5% or more, 3.8% or more, 3.9% or more, 6.5% or more, 9.5% or more, 12.5% or more, even 15.5% or more while at the same time is 20% or less, and can be 19.5% or less, 19.4% or less, 17% or less, 14% or less, 11% or less, or even 8% or less.

The polymer A and/or the polymer B of the multistage polymer may each independently comprise structural units of monomer (e) the acetoacetoxy or acetoacetamide functional monomer. Monomer (e) is as described above, and desirably, AAEM. The polymer A may comprise, by weight based on the weight of the polymer A, structural units of monomer (e) at a concentration of from zero to 5%, and can be zero or more, 1% or more, 2% or more, 3% or more, even 4% or more while at the same time is 5% or less, and can be 4.5% or less, 3.5% or less, 2.5% or less, 1.5% or less, 1% or less, 0.5% or less, 0.1% or less, or even less than 0.1%, and desirably, less than 0.1%. More desirably, the polymer A is substantially free of structural units of monomer (e), e.g., zero to less than 0.1% by weight of monomer (e) based on the weight of the polymer A. The polymer B may comprise, by weight based on the weight of the polymer B, structural units of monomer (e) at a concentration of from 3.5% to 10%, and can be 3.5% or more, 3.8% or more, 3.9% or more, 4.0% or more, 4.5% or more, 5.5% or more, 6.5% or more, 7.5% or more, 8.5% or more, even 9.5% or more while at the same time is 10% or less, and can be 9.8% or less, 9.7% or less, 9.5% or less, 9% or less, 8% or less, 7.5% or less, 7% or less, 6% or less, 5% or less, or even 4.5% or less, and desirably, 4.5% to 7.5%. The polymer A and the polymer B may each independently have a Fox Tg of 40° C. or less, 20° C. or less, 0° C. or less, or even less than 0° C.

The polymer A and/or the polymer B in the multistage polymer may each independently comprise structural units of monomer (f) the hard monomer. Monomer (f) is as described above, and desirably, monomer (f) is a hard acrylic monomer such as MMA. The polymer A may comprise, by weight based on the weight of the polymer A, structural units of monomer (f) at a concentration of from 13% to 21%, and can be 13% or more, 14% or more, 15% or more, 16% or more, even 17% or more while at the same time is 21% or less, and can be 20% or less, 19% or less, 18% or less, or even 17% or less. The polymer B may comprise, by weight based on the weight of the polymer B, structural units of monomer (f) at a concentration of from 12% to 20%, and can be 12% or more, 13% or more, 14% or more, 15% or more, even 16% or more while at the same time is 20% or less, and can be 19% or less, 18% or less, 17% or less, or even 16% or less.

The polymer A and/or the polymer B in the multistage polymer may each independently comprise structural units of monomer (g) the additional ethylenically unsaturated nonionic monomer. Monomer (g) is as described above. The polymer A may comprise, by weight based on the weight of the polymer A, structural units of monomer (g) at a concentration of from zero to 5%, and can be zero or more, 1% or more, 2% or more, 3% or more, even 4% or more while at the same time is 5% or less, and can be 4% or less, 3% or less, 2% or less, 1% or less, or even zero. The polymer B may comprise, by weight based on the weight of the polymer B, structural units of monomer (g) at a concentration of from zero to 6%, and can be zero or more, 1% or more, 2% or more, 3% or more, even 4% or more while at the same time is 6% or less, and can be 5% or less, 4% or less, 3% or less, 2% or less, or even zero.

Desirably, the polymer A, typically in the first stage, comprises from 25% to 37% of structural units of monomer (a), such as DBI; from 0.5% to 5.5% of structural units of the ethylenically unsaturated functional monomer, such as MAA, SSS, AMPS, or mixtures thereof; from 26% to 50% of structural units of ethyl (meth)acrylate, such as EA; from 4% to 21% of structural units of the long-chain alkyl (meth)acrylate, such as lauryl methacrylate, tetradecyl methacrylate, hexadecyl methacrylate, or mixtures thereof; from zero to 5% (desirably, zero to less than 0.1%) of structural units of AAEM, from 13% to 21% of structural units of the hard monomer, such as the hard acrylic monomer; and from zero to 6% of structural units of the additional ethylenically unsaturated nonionic monomer; by weight based on the weight of the polymer A. At the same time, desirably, the polymer B, typically in the second stage, comprises from 23% to 34% of structural units of monomer (a) such as DBI; from 0.5% to 5% of structural units of the ethylenically unsaturated functional monomer, such as MAA, SSS, AMPS and mixtures thereof; from 24% to 48% of structural units of ethyl (meth)acrylate, such as EA; from 3.5% to 20% of structural units of the long-chain alkyl (meth)acrylate, such as lauryl methacrylate, tetradecyl methacrylate, hexadecyl methacrylate, or mixtures thereof; from 3.5% to 10% of structural units of AAEM; from 12% to 20% of structural units of the hard monomer, such as the hard acrylic monomer; and from zero to 5% of structural units of the additional ethylenically unsaturated nonionic monomer; by weight based on the weight of the polymer B.

The polymer A and the polymer B of the multistage polymer may be present at a weight ratio of the polymer A to the polymer B in a range of 5:95 to 95:5, can be 10:90 to 90:10, 20:80 to 80:20, 30:70 to 70:30, or 40:60 to 60:40, and desirably, 30:70 to 70:30 or even 50:50.

The total weight concentration of structural units in the polymer A and in the polymer B is each equal to 100% relative to the polymer A weight and polymer B weight, respectively.

The emulsion polymer in the aqueous dispersion is a biobased polymer that is suitable for use as a biobased binder in paints and coatings. The emulsion polymer may have a biobased carbon content of greater than 40%, and desirably, 50% or more, and can be 51% or more, 52% or more, 53% or more, 54% or more, or even 55% or more, as measured according to ASTM D6866-22 or calculated according to the Biobased Carbon Content Calculated Method described in the Examples section below.

The aqueous dispersion of the present invention may comprise or be free of an epoxy functional silane, an amino functional silane, or mixtures thereof. Examples of suitable epoxy functional silanes include β-(3,4-epoxy-cyclohexyl)-ethyltrimethoxysilane, γ-glycidoxypropyltrimethoxysilane, γ-glycidoxypropylmethyldiethoxysilane, γ-glycidoxypropyltriethoxysilane, or hydrolyzates thereof; an epoxy silane oligomer; or mixtures thereof.

Desirably, the epoxy functional silane is an epoxy silane oligomer. The epoxy silane oligomer is typically a saturated epoxy functional polysiloxane oligomer. “Oligomer” herein refers to a polymer having a number-average molecular weight of from 200 to 3,000, from 300 to 2,000, or from 350 to 1,000. The number-average molecular weight (Mn) of the epoxy oligomer can be measured by gel permeation chromatography (GPC) using an Agilent 1200. A sample is dissolved in tetrahydrofuran (THF) with a concentration of 5 mg/mL and then filtered through 0.45 μm polytetrafluoroethylene (PTFE) filter prior to the GPC analysis. Conditions for the GPC analysis are as follows, Column: One PLgel GUARD columns (10 μm, 50×7.5 mm), two Polymer Laboratories Mixed E columns (7.8×300 mm) in tandem; column temperature: 40° C.; mobile phase: THF; flow rate: 1.0 mL/minute; Injection volume: 50 L; detector: Agilent Refractive Index detector, 40° C.; and calibration curve: PL Polystyrene Narrow standards with molecular weights ranging from 580 to 19760 g/mol, using polynom 3 fitness. The peak molecular weight (Mp) used for narrow calibration is values converted from Mp of each PS standard using following equation: Mₚ=1.0951 Mp of PS^{0.9369}. The epoxy silane oligomer useful in the present invention may have the structure of formula (II):

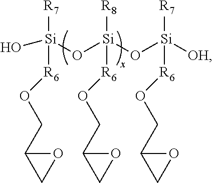

where x is from 0 to 14, preferably, from 0 to 4, from 1 to 4, or from 1 to 3; R₆ is —CH₂CH₂CH₂—; and R₇ and R₈ each independently represent —OH, —OCH₃, —OCH₂CH₃, or —CH₃. The epoxy silane oligomer can be a mixture of oligomers having the structure of formula (I) with different x values, for example, 0, 1, 2 or 3.

Suitable amino-functional silanes may include silanes having the structure of formula (III):

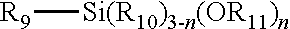

where n is 1, 2, or 3; R₉ is alkyl, cycloalkyl, phenyl, cycloalkylalkyl, alkenylcycloalkyl, alkenylphenyl (e.g., benzyl), or phenylalkyl (e.g., tolyl), wherein R₉ contains at least one amino group; each R₁₀ and R₁₁ are each independently hydrogen, alkyl, cycloalkyl, phenyl, cycloalkylalkyl, alkenylcycloalkyl, alkenylphenyl (e.g., benzyl) or phenylalkyl (e.g., tolyl). Desirably, n is 1 or 2, R₁₁ is a methyl or ethyl group, and R₉ is an alkyl group having from 3 to 8 carbon atoms and containing at least one amino group.

Exemplary amino-functional silanes include trimethoxysilylpropyldiethylenetriamine, N-methylaminopropyltrimethoxysilane, aminoethylaminopropylmethyldimethoxysilane, aminoethylaminopropyltrimethoxysilane, aminopropylmethyldimethoxysilane, aminopropyltrimethoxysilane, polymeric aminoalkyl silicone, aminoethylaminoethylaminopropyl-trimethoxysilane, aminopropylmethyldiethoxysilane, aminopropyltriethoxysilane, 4-aminobutyltriethoxysilane, oligomeric aminoalkylsilane, m-aminophenyltrimethoxysilane, phenylaminopropyltrimethoxysilane, 1,1,2,4-tetramethyl-1-sila-2-azacyclopentane, aminoethylaminopropyltriethoxysilane, aminoethylaminoisobutylmethyldimethoxysilane, and benzyl ethylenediaminepropyltrimethoxysilane; hydrolyzates thereof; or mixtures thereof.

The aqueous dispersion of the present invention may comprise the epoxy functional silane and/or the amino functional silane at a concentration of 0.03% to 3%, and can be 0.03% or more, 0.05% or more, 0.1% or more, 0.15% or more, 0.2% or more, 0.25% or more, 0.3% or more, 0.35% or more, even 0.4% or more while at the same time is 3% or less, and can be 2.5% or less, 2% or less, 1.5% or less, 1.2% or less, 1% or less, 0.9% or less, 0.8% or less, 0.7% or less, 0.6% or less, or even 0.5% or less, and desirably, from 0.05% to 1% or from 0.1% to 0.5%, by weight based on the weight of the emulsion polymer.

The aqueous dispersion of the present invention may comprise or be free of one or more polyoxypropylene polyols, that is, poly(propylene oxide) homopolymers. The polyoxypropylene polyols may have a number average molecular weight (M) of 350 to 3500, and can be 350 or more, 360 or more, 370 or more, 375 or more, 380 or more, 390 or more, 400 or more, 410 or more, 420 or more, 430 or more, 440 or more, even 450 or more while at the same time is 3,500 or less, and can be 3,400 or less, 3,200 or less, 3,000 or less, 2,800 or less, 2,500 or less, 2,300 or less, 2,000 or less, 1,800 or less, 1,600 or less, 1,500 or less, 1,200 or less, 1,000 or less, 900 or less, 800 or less, 700 or less, 650 or less, 600 or less, 550 or less, or even 500 or less. Mₙ herein may be measured by Gel Permeation Chromatography (GPC) or by calculation according to equation (i) below. For example, Mₙ of the polyoxypropylene polyol can be measured by SEC on two Polymer Laboratories Mixed E columns (in tandem) with refractive index detector at 40° C. using polystyrene narrow standards. Molecular weights of polystyrene standards used for calibration range from 2329,000 to 580 g/mol. Peak molecular weight (Mₚ) used for calibration are values converted from peak molecular weight of each PS standard (“M_{p-PS}”) according to the following equation: Mₚ=1.0951*M_{p-PS} 9369. Mn of the polyoxypropylene polyol can also be calculated by the equation (i) below,

$${M}_{n} = ( functionality of polyol * 56100 ) / hydroxy number of polyol$$

where hydroxy number, reported in units of milligrams of KOH/gram of polyol, is measured according to the ASTM D4274-16 method (Standard Test Methods for Testing Polyurethane Raw Materials: Determination of Hydroxyl Numbers of Polyols). Generally, the polyoxypropylene polyol may have an average hydroxy functionality of 2 or more or 3 or more while at the the same time is generally 6 or less, and can be 5 or less, or even 4 or less.

The polyoxypropylene polyol useful in the present invention may be initiated with, for example, water, organic dicarboxylic acids such as succinic acid, adipic acid, phthalic acid, terephthalic acid; or polyhydric alcohols (such as dihydric to pentahydric alcohols or dialkylene glycols), for example, ethanediol, 1,2- and 1,3-propanediol, diethylene glycol, dipropylene glycol, 1,4-butanediol, 1,6-hexanediol, glycerol, trimethylolpropane, pentaerythritol, sorbitol, and sucrose or blends thereof; linear and cyclic amine compounds which may also contain a tertiary amine such as ethanoldiamine, triethanoldiamine, and various isomers of toluene diamine, methyldiphenylamine, aminoethylpiperazine, ethylenediamine, N-methyl-1,2-ethanediamine, N-methyl-1,3-propanediamine, N,N-dimethyl-1,3-diaminopropane, N,N-dimethylethanolamine, diethylene triamine, bis-3-aminopropyl methylamine, aniline, aminoethyl ethanolamine, 3,3-diamino-N-methylpropylamine, N,N-dimethyldipropylenetriamine, aminopropyl-imidazole and mixtures thereof; or combinations thereof. Suitable commercially available polyoxypropylene polyols may include, for example, VORANOL™ 2000LM polyol, VORANOL CP450 polyol and VORANOL 3000LM polyol, all available from The Dow Chemical Company; and mixtures thereof (VORANOL is a trademark of The Dow Chemical Company).

The aqueous dispersion of the present invention may comprise the polyoxypropylene polyol at a concentration of 1% to 10%, and can be 1% or more, 1.5% or more, 2% or more, 2.5% or more, 3% or more, 3.5% or more, 4% or more, 4.5% or more, 5% or more, 5.5% or more, even 6% or more while at the same time is 10% or less, and can be 8% or less, 6% or less, or even 4% or less, and desirably, from 1.5% to 5% or from 2% to 4%, by weight based on the weight of the emulsion polymer.

The aqueous dispersion of the present invention can be prepared by a method including emulsion polymerization of monomers comprising or consisting of the monomers described above such as monomer (a), monomer (b), monomer (c), monomer (d), monomer (e), monomer (f), and monomer (g) if present. Each monomer described above after polymerization forms structural units of such monomer in the emulsion polymer (and in the polymer A and/or polymer B for the multistage polymer). Total weight concentration of monomers for preparing the emulsion polymer is equal to 100%, based on the total weight of monomers used in preparing the emulsion polymer. One-stage or multistage emulsion polymerization can be used. When the emulsion polymer is a multistage polymer, multistage free-radical polymerization is used, which involves at least two stages formed sequentially (e.g., the first stage and the second stage) and usually results in the formation of the multistage polymer comprising at least two polymer compositions, i.e., the polymer A and the polymer B, optionally different stages can be formed in different reactors. Each stage of the multistage polymerization can be conducted by polymerization techniques well known in the art. Each of the stages is sequentially polymerized and different from the immediately preceding and/or immediately subsequent stage by a difference in monomer composition. The multistage polymerization may comprise at least one stage of polymerization forming the polymer A, followed by at least one stage of polymerization forming the polymer B. For example, the multistage polymerization may include i) forming the polymer A by polymerization of the monomer mixture A, and ii) forming the polymer B by polymerization of the monomer mixture B, in the presence of the polymer A obtained from step i); thereby forming the multistage polymer. Desirably, the polymer A is in the first stage and the polymer B is in the second stage of the multistage polymerization. The monomer mixture A and the monomer mixture B may each independently comprise the monomers described above used for forming the structural units of the polymer A and the polymer B, respectively. The monomer mixture A and the monomer mixture B may each independently comprise the above described monomers including monomers (a), (b), (c), (d), (e), (f) and (g) if present. Total weight concentration of the monomers in the monomer mixture A for preparing the polymer A is equal to 100%, relative to the weight of monomers in the monomer mixture A. Total weight concentration of the monomers in the monomer mixture B is equal to 100%, relative to the weight of monomers in the monomer mixture B. The monomer mixture A and the monomer mixture B are used in amounts to provide a weight ratio of monomers in the monomer mixture A to monomers in the monomer mixture B the same as the weight ratio of the polymer A to the polymer B as described above, for example, in a range of 5:95 to 95:5.

The mixture of monomers may be added neat or as an emulsion in water; or added in one or more additions or continuously, linearly or nonlinearly, over the reaction period of preparing the emulsion polymer. Temperature suitable for emulsion polymerization process may be lower than 100° C., in a range of from 30° C. to 95° C., or in a range of from 50° C. to 90° C. One or more surfactants may be used in preparing the emulsion polymer. The surfactant may be added prior to, during, or after the polymerization of the monomer mixture, or combinations thereof. These surfactants may include anionic and/or nonionic emulsifiers, such as, for example, phosphate surfactants, sulfates surfactant, sulfonates surfactant and succinates surfactant. Some of commercially available surfactants include DISPONIL FES 32 and DISPONIL FES 993 fatty alcohol ether sulfates available from BASF; RHODAFAC RS-610 fatty alcohol ether phosphate, AEROSOL A-102 sulfosuccinate surfactant, and sodium dodecylbenzene sulfonate surfactant all from Solvay from Solvay; sodium lauryl sulfate from Stepan, TERGITOL™ 15-S-40 secondary alcohol ethoxylate available from Dow Chemical Company (TERGITOL is a trademark of The Dow Chemical Company). The surfactant is usually used in an amount of zero to 5% and can be from 0.5% to 3% or from 0.8% to 2%, by weight based on the total weight of monomers used for preparing the emulsion polymer.

In the polymerization process, free radical initiators and/or chain transfer agents may be used. The polymerization process may be thermally initiated or redox initiated emulsion polymerization. The free radical initiators can be water-soluble initiators. Examples of suitable free radical initiators include hydrogen peroxide, t-butyl hydroperoxide, cumene hydroperoxide, ammonium and/or alkali metal persulfates, sodium perborate, perphosphoric acid, and salts thereof; potassium permanganate, and ammonium or alkali metal salts of peroxydisulfuric acid. The free radical initiators may be used typically at a level of 0.01% to 3.0% by weight, based on the total weight of monomers. Redox systems comprising the above described initiators coupled with a suitable reductant may be used in the polymerization process. Examples of suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the proceeding acids. Metal salts of iron, copper, manganese, silver, platinum, vanadium, nickel, chromium, palladium, or cobalt may be used to catalyze the redox reaction. Chelating agents for the metals may optionally be used. Examples of suitable chain transfer agents include 3-mercaptopropionic acid, n-dodecyl mercaptan (n-DDM), methyl 3-mercaptopropionate, butyl 3-mercaptopropionate, benzenethiol, azelaic alkyl mercaptan, or mixtures thereof. The chain transfer agent may be used in an effective amount to control the molecular weight of the emulsion polymer, for example, from zero to 1%, and can be from 0.05% to 0.5%, or from 0.1% to 0.4%, by weight based on the total weight of monomers used for preparing the emulsion polymer.

After completing the polymerization, the obtained aqueous dispersion may be neutralized by one or more bases as neutralizers to a pH value of at least 6, and can be from 6 to 10, or from 7 to 9.5. The bases may lead to partial or complete neutralization of the ionic or latently ionic groups of the emulsion polymer. Examples of suitable bases include ammonia; alkali metal or alkaline earth metal compounds such as sodium hydroxide, potassium hydroxide, calcium hydroxide, zinc oxide, magnesium oxide, sodium carbonate; primary, secondary, and tertiary amines, such as triethyl amine, ethylamine, propylamine, monoisopropylamine, monobutylamine, hexylamine, ethanolamine, diethyl amine, dimethyl amine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, neopentanediamine, dimethylaminopropylamine, hexamethylenediamine, 4,9-dioxadodecane-1,12-diamine, polyethyleneimine or polyvinylamine; aluminum hydroxide; or mixtures thereof. The process of preparing the emulsion polymer can reduce coagulum formation. The obtained aqueous dispersion of the present invention may contain less than 500 parts per million (ppm), and can be less than 400 ppm, less than 300 ppm, less than 275 ppm, less than 200 ppm, or even less than 150 ppm, of coagulum, by weight relative to the weight of the aqueous dispersion, when filtering with a 100 mesh (150 micrometers) sieve (further details provided below under the Wet Coagulum Content Test).

The emulsion polymer particles in the aqueous dispersion of the present invention may have a particle size of from 60 nanometers (nm) to 300 nm, and can be 60 nm or higher, 70 nm or higher, 80 nm or higher, 100 nm or higher, greater than 100 nm, 110 nm or higher, 120 nm or higher, even 130 nm or higher while at the same time is 300 nm or less, and can be 280 nm or less, 250 nm or less, 220 nm or less, or even 200 nm or less. The particle size herein refers to Z-average size and may be measured using a Brookhaven BI-90 Plus Particle Size Analyzer.

The aqueous dispersion comprising the emulsion polymer is suitable for coating applications, particularly useful for zero- or low-VOC coating applications where balanced properties are desired. The aqueous dispersion of the present invention can achieve good water whitening resistance with delta L<7 after 4 hours in water, as determined according to the Water Whitening Resistance Test. At the same time, the aqueous dispersion provides coating compositions comprising thereof with good freeze-thaw stability and also enables coatings made therefrom to pass the peel-off resistance test and show good early chalking resistance with ratings ≤3, and good scrub resistance. “Good freeze-thaw stability” (that is, being freeze-thaw stable) means that a composition can be subjected to three freeze-thaw cycles (from −6° C. to room temperature (25° C.)) showing no coagulation or grit and a viscosity change of no more than 10 Krebs units (KU). “Good scrub resistance” is indicated by the total number of cycles for cut-through coatings greater than 80%, and desirably, 95% or more, relative to a reference coating composition (i.e., Comp Paint A in the Examples section below). Further details of the above test methods can be found in the Examples section below.

The present invention also relates to a coating composition comprising such aqueous dispersion. The coating composition of the present invention may comprise less than 10 grams of volatile organic compounds (VOCs) per liter (g/L) of the coating composition (hereinafter referred to as “VOC content”), as measured according to GB 18582-2008 method. The VOC content of the coating composition can be less than 10 g/L, less than 8 g/L, less than 6 g/L, less than 4 g/L, or even less than 2 g/L. The coating composition of the present invention may have a biobased carbon content of 20% or more, as determined by ASTM D6866-22.

The coating composition of the present invention may comprise or be free of one or more pigments and/or extenders. As used herein, the term “pigment” refers to a particulate inorganic material which is capable of materially contributing to the opacity or hiding capability of a coating. Such materials typically have a refractive index greater than 1.8 and include inorganic pigments and organic pigments. Examples of suitable inorganic pigments include titanium dioxide (TiO₂), zinc oxide, zinc sulfide, iron oxide, barium sulfate, barium carbonate, or mixtures thereof. Preferred pigment used in the present invention is TiO₂. TiO₂ may be also available in concentrated dispersion form. The term “extender” refers to a particulate inorganic material having a refractive index of less than or equal to 1.8 and greater than 1.3. Examples of suitable extenders include calcium carbonate, aluminum oxide (Al₂O₃), clay, calcium sulfate, aluminosilicate, silicate, zeolite, mica, diatomaceous earth, solid or hollow glass, ceramic bead, and opaque polymers such as ROPAQUE™ Ultra E available from The Dow Chemical Company (ROPAQUE is a trademark of The Dow Chemical Company), or mixtures thereof. The coating composition may have a pigment volume concentration (PVC) of from 30% to 70%, from 40% to 60%, or from 45% to 55%. PVC of a coating composition may be determined according to the following equation:

$$PVC = \frac{volume of pigment ( s ) + volume of extender ( s )}{total dry volume of coating composition} * 100 \%$$

The coating composition of the present invention may comprise or be free of one or more defoamers. “Defoamers” herein refer to chemical additives that reduce and hinder the formation of foam. Defoamers may be silicone-based defoamers, mineral oil-based defoamers, ethylene oxide/propylene oxide-based defoamers, or mixtures thereof. Suitable commercially available defoamers include, for example, TEGO Airex 902 W and TEGO Foamex 1488 polyether siloxane copolymer emulsions both available from TEGO, BYK-024 silicone deformer available from BYK, or mixtures thereof. The defoamer may be present, by weight based on the total weight of the coating composition, in an amount of generally from zero to 0.5%, from 0.05% to 0.4%, or from 0.1% to 0.3%.

The coating composition of the present invention may comprise or be free of one or more thickeners, also known as “rheology modifiers”. The thickeners may include polyvinyl alcohol (PVA), acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. Desirably, the thickener is selected from HASE, HEC, HEUR, or mixtures thereof. The thickener may be present, by weight based on the total weight of the coating composition, in an amount of generally from zero to 3.0%, from 0.1% to 1.5%, or from 0.2% to 1.2%.

The coating composition of the present invention may comprise or be free of one or more wetting agents. “Wetting agents” herein refer to chemical additives that reduce the surface tension of a coating composition, causing the coating composition to more easily spread across or penetrate the surface of a substrate. Wetting agents may be polycarboxylates, anionic, zwitterionic, or non-ionic. Suitable commercially available wetting agents include, for example, TRITON™ CF-10 nonionic surfactant available from The Dow Chemical Company (TRITON is a trademark of The Dow Chemical Company), SURFYNOL 10 nonionic wetting agent based on an actacetylenic diol available from Air Products, BYK-346 and BYK-349 polyether-modified siloxanes both available from BYK, or mixtures thereof. The wetting agent may be present, by weight based on the total weight of the coating composition, in an amount of from zero to 1.0%, from 0.1% to 0.8%, or from 0.2% to 0.6%.

The coating composition of the present invention may comprise or be free of one or more coalescents. “Coalescents” herein refer solvent that fuses polymer particles into a continuous film under ambient condition. Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include TEXANOL ester alcohol available from Eastman Chemical Company, Coasol and Coasol 290 Plus coalescents available from Chemoxy International Ltd., dipropylene glycol n-butyl ether, ethylene glycol monobutyl ether, diethylene glycol monobutyl ether, n-butyl ether, or mixtures thereof. Desirably, the coalescent has a boiling point >280° C. at room temperature and a pressure of 101.325 kilopascals (kPa). The coalescent may be present, by weight based on the total weight of the coating composition, in an amount of from zero to 5%, from 0.1% to 2.0%, or from 0.2% to 1.5%.

The coating composition of the present invention may comprise or be free of one or more dispersants. The dispersants may include non-ionic, anionic and cationic dispersants such as polyacids with suitable molecular weight, 2-amino-2-methyl-1-propanol (AMP), dimethyl amino ethanol (DMAE), potassium tripolyphosphate (KTPP), trisodium polyphosphate (TSPP), citric acid and other carboxylic acids. The polyacids used may include homopolymers and copolymers based on polycarboxylic acids (e.g., molecular weight ranging from 1,000 to 50,000 as measured by GPC), including those that have been hydrophobically- or hydrophilically-modified, e.g., polyacrylic acid or polymethacrylic acid or maleic anhydride with various monomers such as styrene, acrylate or methacrylate esters, diisobutylene, and other hydrophilic or hydrophobic comonomers; salts of thereof; or mixtures thereof. The dispersant may be present, by weight based on the total weight of the coating composition, in an amount of from zero to 1.0%, from 0.1% to 0.8%, or from 0.2% to 0.6%.

The coating composition of the present invention may comprise or be free of one or more anti-freeze agents without contributing VOCs. Specific examples of anti-freeze agents include polyethylene glycol, Strodex FT-68 available from Ashland, RHODOLINE FT-100 available from Solvay, or mixtures thereof. The anti-freeze agent may be present in an amount of zero to 0.5%, and can be 0.4% or less, or 0.1% or less, of the anti-freeze agent, by weight based on the total weight of the coating composition. Desirably, the coating composition is substantially free of the anti-freeze agents, e.g., at a concentration of less than 0.1%, less than 0.05%, or even zero, by weight based on the total weight of the coating composition.

In addition to the components described above, the coating composition of the present invention may further comprise any one or combination of the following additives: buffers, neutralizers, humectants, mildewcides, biocides, anti-skinning agents, colorants, flowing agents, crosslinkers, anti-oxidants, plasticizers, leveling agents, thixotropic agents, adhesion promoters, and grind vehicles. These additives may be present in a combined amount of from zero to 1% or from 0.1% to 0.8%, by weight based on the total weight of the coating composition.

The coating composition of the present invention may further comprise water typically present in an amount of from 30% to 90%, from 40% to 80%, or from 50% to 70%, by weight based on the total weight of the coating composition.

The present invention also relates a method of making the coating composition. The method may comprise: admixing the aqueous dispersion of the present invention, and optionally, a pigment and/or an extender, and/or other optional components described above. Components in the coating composition may be mixed in any order to provide the coating composition of the present invention. Any of the above-mentioned optional components may also be added to the composition during or prior to the mixing to form the coating composition. The pigments and/or extenders are preferably mixed with the dispersant to form a slurry of pigments and/or extender.

The present invention also relates to a process for preparing a coating. The process may comprise: providing the coating composition of the present invention, applying the coating composition to a substrate, and drying, or allowing to dry, the applied coating composition to form the coating. The coating composition can be applied to, and adhered to, various substrates. Examples of suitable substrates include wood, metals, plastics, foams, stones, elastomeric substrates, glass, wall paper, fabrics, medium-density fiberboard (MDF), particle board, gypsum board, concrete, or cementious substrates. The coating composition can be applied to a substrate by incumbent means including brushing, dipping, rolling and spraying, and desirably spraying. The standard spray techniques and equipment for spraying such as air-atomized spray, air spray, airless spray, high-volume low-pressure spray, and electrostatic spray such as electrostatic bell application, and either manual or automatic methods can be used. After the coating composition has been applied to a substrate, the coating composition can dry, or allow to dry, to form a film (this is, coating or coating film) at room temperature, or at an elevated temperature, for example, from 35 to 60° C. The coating composition can be used alone, or in combination with other coatings to form multi-layer coatings.

The coating composition of the present invention is suitable for various applications such as marine and protective coatings, automotive coatings, traffic paint, Exterior Insulation and Finish Systems (EIFS), roof mastic, wood coatings, coil coatings, plastic coatings, can coatings, architectural coatings, and civil engineering coatings. The coating composition is particularly useful for architectural coatings.

### EXAMPLES

Some embodiments of the invention will now be described in the following Examples, wherein all percentages (%) are weight percentages relative to the composition weight unless otherwise specified. Table 1 lists the materials for preparing aqueous polymer dispersions used as binders described herein below. Note: OROTAN, ACRYSOL, VORANOL and ROPAQUE are trademarks of The Dow Chemical Company.

TABLE 1
Monomers and ingredients used for preparing polymer dispersions

| | Abbreviation/Product | | |
|---|---|---|---|
| Function | name | Chemical description | Commercial source |
| Surfactant | Disponil ™ FES 993 | Alkyl ethoxylated sulfate | BASF |
| | Disponil ™ FES 32 | Alkyl ethoxylated sulfate | |
| Monomer | EA | Ethyl acrylate | The Dow Chemical Company |
| | LMA 1214F | Mixture of 62-78% (lauryl methacrylate) | BASF |
| | | (“C₁₂MA”) and 22-38% (tetradecyl | |
| | | methacrylate) (“C₁₄MA”) and 0-10% | |
| | | hexadecyl methacrylate (“C₁₆MA”), by | |
| | | weight based on the weight of LMA | |
| | | 1214F. | |
| | MMA | Methyl methacrylate | Evonik |
| | DBI | Dibutyl itaconate | Guangzhou Shuangjian Trading Co., Ltd. |
| | DEI | Diethyl itaconate | (China) |
| | AAEM | Acetoacetoxyethyl methacrylate | Eastman |
| | GMAA | Methacrylic acid | The Dow Chemical Company |
| | DAAM | Diacetone acrylamide | Kyowa Hakko Bio Co., Ltd. |
| | C₁₈MA | Octadecyl methacrylate | Sinopharm Chemical Reagent Co., Ltd. |
| | SSS | Sodium styrenic sulfonate | |
| Chain transfer agent | n-DDM | n-dodecyl mercaptan | |
| Initiator | SPS | Sodium persulfate | |
| | t-BHP | tert-butyl hydrogen peroxide | |
| | SBS | Sodium bisulfite | |
| Neutralizer | KOH | Potassium hydroxide | |
| | Na₂CO₃ | Sodium carbonate | |
| | MEA | Monoethanol amine | |
| | JEFFAMINE D-230 | Polyetheramine | Huntsman Chemical Co., Ltd. |
| Additive | VORANOL ™ CP 450 | Polyoxypropylene polyol having Mn of | The Dow Chemical Company |
| | SH Polyol | 450 and an average hydroxy | |
| | | functionality of 3 | |
| | COATOSIL MP 200 | Epoxy functional silane oligomer | Momentive Performance Materials Inc. |
| | FeSO₄•7H₂O | | Sinopharm Chemical Reagent Co., Ltd. |
| | EDTA | Ethylenediaminetetraacetic acid | The Dow Chemical Company |
| | | disodium salt dihydrate | |
| | ADH | Adipic dihydrazide | Sinopharm Chemical Reagent Co., Ltd. |

The following standard analytical equipment and methods are used in the Examples and in determining the properties and characteristics stated herein:

### Biobased Carbon Content Calculated Method

For a polymer comprising structural units of M1, M2, . . . , Mi monomers, the biobased carbon content of such polymer can be calculated according to the equation below,

$$Biobased carbon content = \frac{{\sum }_{i = 1}^{i} \frac{Ai}{Wi} * RCi}{{\sum }_{i = 1}^{i} \frac{Ai}{Wi} * TCi} * 100$$

where A1, A2, . . . , and Ai represent the dosage of monomers, in gram; W1, W2, . . . , and Wi represent the molecular weight of monomers, in gram/mole; RC1, RC2, . . . , and RCi represent the renewable carbon number of monomers; and TC1, TC2, . . . , and TCi represent the total carbon number of monomers.

For calculating the BCC of emulsion polymers prepared in the Examples section, the reference molecular weight, renewable carbon number, and total carbon number of monomers that were used in preparing these emulsion polymers are listed below.

| | Molecular | Number of renewable | Total number of |
|---|---|---|---|
| Monomer | weight | carbon atoms | carbon atoms |
| EA | 100 | 2 | 5 |
| LMA 1214F | 254 | 12 | 16 |
| C₁₈MA | 338 | 18 | 22 |
| BA | 128 | 0 | 7 |
| MAA | 86 | 0 | 4 |
| AA | 72 | 0 | 3 |
| SSS | 206 | 0 | 8 |
| AAEM | 214 | 0 | 10 |
| ST | 104 | 0 | 8 |
| MMA | 100 | 0 | 5 |
| DBI | 242 | 13 | 13 |
| DEI | 186 | 9 | 9 |
| DAAM | 169 | 0 | 9 |

*When calculating the biobased carbon content of a polymer made from LMA 1214F, the molecular weight, number of renewable carbon atoms and total number of carbon atoms of lauryl methacrylate were used for the calculation.

### Freeze/Thaw (F/T) Stability Test

A coating composition sample was prepared and stored at room temperature for 24 hours. Then, the KU viscosity of the coating composition sample was measured according to ASTM D562-10 (2014) using a Stormer viscometer and recorded as “Initial KU”. Containers were filled with 75% volume of the test coating composition. The containers were sealed and placed into a freezer at −6° C. for 16 hours, and then taken out from the freezer to allow to thaw at room temperature for 8 hours. The above steps complete one F/T cycle. The F/T cycles were continued until the sample coagulated or to a maximum of three cycles. After each cycle, the cycle number was recorded if coagulation or gel (or grit) had been observed. After the completion of 3 cycles, the sample was shaken manually to observe the appearance by the naked eye. A delta KU was recorded relative to the initial KU. If no grit or coagulum is observed and delta KU is no more than 10 (≤10), the sample is rated as “Pass” indicating good freeze-thaw stability. Otherwise, if the sample coagulates, has grits separated, or the delta KU is higher 10, the sample is rated as “Fail” indicating poor freeze-thaw stability.

### Scrub Resistance Test

Scrub resistance test was conducted according to ASTM D2486-17 test method B. A coating composition sample was cast on a black vinyl panel (Type P-121-10N, The Leneta Company) using a 175 μm film caster and then air-dried in a horizontal position for 7 days in a Constant Temperature Room (CTR, 23±2° C. and 50±5% relative humidity). The scrub resistance test was performed on a Sheen machine Model REF903 equipped with a metal tray and nylon bristle brush. The brush was soaked in water overnight before use and then mounted in a holder with the brush's bristle-side down to start the test. Ten grams of standardized scrub medium (Type SC-2, The Leneta Company) was applied on brush surface. The number of cycles for cutting through coating films for each sample was recorded. The scrub resistance of Comp Paint A sample is reported as 100%, and the scrub resistance of other samples are calculated and reported as relative percentage values to that of Comp Paint A. A relative percentage of greater than 80% (>80%), and desirably, 95% or more, means good scrub resistance. The higher the relative percentage, the better scrub resistance.

### Peel-Off Resistance Test

A coating composition sample was casted on a black vinyl panel (Type P-121-10N, The Leneta Company) using a 150 μm film caster and then air-dried in a horizontal position for 7 days in a Constant Temperature Room (CTR, 23±2° C. and 50±5% relative humidity). The peel-off resistance test was performed on a washability tester (Model JTX-III, Shanghai Modem Environment Engineering Technology Co., Ltd.). The coating film formed on the test_panel was rubbed using gauze soaked with the 2% detergent solution under 1.5 kilograms (kg) weight. After the test panel was rubbed for 200 cycles, it was removed from the tester and observed by the naked eye. If the coating film is removed from the black vinyl chart such that the black substrate is visible, the sample fails the peel-off resistance test and recorded as “Fail”. Otherwise, if no coating film is removed from the black vinyl chart and no black substrate is visible, the test panel passes the peel-off resistance test and recorded as “Pass”.

### Early Chalking Resistance Test

A coating composition sample was casted on a black vinyl panel (Type P-121-10N, The Leneta Company) using a 175 μm film caster and then air-dried in a horizontal position for 1 day in a CTR. Then the resulting coating film formed on the panel was rubbed with a black fabric for 10 cycles and evaluated by comparing white powder left on the rubbed black fabric with the pictorial reference standards shown in FIG. 1 in the ISO 4628-6 standard and the degree of early chalking is rated as 1-5. The rating of no higher than 3 (≤3) indicates good early chalking resistance. Otherwise, if the rating is higher than 3, it indicates poor early chalking resistance.

### Water Whitening Resistance Test

An aqueous dispersion comprising an emulsion polymer (also as “latex”) was applied on a vinyl chart by using a 100 μm film caster. After air-dried in a CTR for 24 hours, initial L value (denoted as “L₀”) of the resulting clear film was tested using a color spectrophotometer. The clear film coated chart was soaked in DI water for 4 hours, and then L value of the clear film was tested (denoted as “L₄ₕ”). The absolute value difference between L₀ and L₄ₕ is defined as the L change, delta L (denoted as “ΔL”). The acceptable ΔL is less than 7 (<7). The smaller ΔL, the better the water whitening resistance of the latex.

### Wet Coagulum Content Test

An aqueous dispersion comprising an emulsion polymer (also as “latex”) was measured to evaluate wet coagulum content formed in the polymerization process for preparing the latex. The test was conducted by weighting the sample (wet weight of the sample is denoted as “W1”) and then filtering the sample through a 100 mesh (150 μm) sieve. The residue remaining on the sieve was collected and weighted as “W2”. The wet coagulum content in ppm is calculated by the below equation:

$$Wet coagulum content = \frac{W2}{W1} * 1000000$$

The acceptable wet coagulum content is <500 ppm. The lower the wet coagulum content, the more stable polymerization process in preparing the aqueous dispersion.

### IEs 1-8 and CEs 1-9 Aqueous Polymer Dispersions

A monomer emulsion (ME) was prepared by mixing deionized (DI) water (470 g), Fes 993 (30% active, 65.13 g), SSS (9.15 g), GMAA (16.8 g), EA (789.51 g), LMA 1214F (82.77 g), DBI (498.64 g), MMA (216.29 g), and n-DDM (2.48 g). A one gallon stirred reactor was charged with DI water (550 g) and Fes-32 (32% active, 1.03 g). After the reactor content was heated to 87° C., 2.06 g Na₂CO₃ in 27 g DI water, 56.7 g of the above prepared ME, FeSO₄·7H₂O (0.02 g), EDTA (0.04 g) in DI water (6 g), and 1.69 g SPS in 32 g DI water were charged to the reactor. When the temperature reached 84° C., the remaining ME and two cofeed solutions of SPS (1.68 g SPS in 54 g water) and SBS (2.52 g SBS in 54 g water), respectively, were added gradually over 120 minutes (min). At the point of 60 min reaction, AAEM (51.2 g) was added into the above remaining ME with agitation. The reactor temperature was maintained at 84° C. After the ME feed and SPS/SBS solution cofeed were all fed into the reactor, DI water (68 g) was used to rinse the ME feed line to the reactor. Then the reactor temperature was cooled to 70° C., followed by feeding a solution of t-BHP (4.05 g t-BHP (70% active) in 70 g water) and a solution of SBS (2.84 g SBS in 70 g water), respectively, into the reactor over 60 min with agitation. When the reactor temperature reached 50° C., neutralizer solution 1 #(5.16 g KOH in 96 g water) and neutralizer solution 2 #(19.91 g MEA and 10.67 g D-230 in 33 g water), respectively, were fed into the reactor over 30 min. Then MP 200 (6.94 g) and CP 450 (107 g) were added into the reactor over 10 min separately. Then the obtained emulsion was filtered to determine the amount of coagulum formed in polymerization process according to the Wet Coagulum Content Test described above.

Unless otherwise stated, other CEs and IEs aqueous polymer dispersion samples were prepared according to the same procedure as above IE 1, except for different monomer compositions listed in Table 2.

### CE 10 Aqueous Polymer Dispersion

A monomer emulsion (ME) was prepared by mixing DI water (470 g), Fes 993 (30% active, 65.13 g), SSS (9.15 g), GMAA (16.8 g), EA (789.51 g), LMA 1214F (82.77 g), DBI (498.64 g), DAAM (49.32 g), MMA (216.29 g), and n-DDM (2.48 g). A one gallon stirred reactor was charged with DI water (550 g) and Fes-32 (32% active, 1.03 g). After the reactor content was heated to 87° C., 2.06 g Na₂CO₃ in 27 g DI water, 56.7 g of the above prepared ME, FeSO₄·7H₂O (0.02 g), EDTA (0.04 g) in DI water (6 g), and 1.69 g SPS in 32 g DI water were charged to the reactor. When the temperature reached 84° C., the remaining ME and two cofeed solutions of SPS (1.68 g SPS in 54 g water) and SBS (2.52 g SBS in 54 g water), respectively, were added gradually over 120 min. The reactor temperature was maintained at 84° C. After the ME feed and SPS/SBS solution cofeed were all fed into the reactor, DI water (68 g) was used to rinse the ME feed line to the reactor. Then the reactor temperature was cooled to 70° C., followed by feeding a solution of t-BHP (4.05 g t-BHP (70% active) in 70 g water) and a solution of SBS (2.84 g SBS in 70 g water), respectively, into the reactor over 60 min with agitation. When the temperature reached to 50° C., neutralizer solutions 1 #(5.16 g KOH in 96 g water) and neutralizer solution 2 #(19.91 g MEA and 10.67 g D-230 in 33 g water), respectively, were fed into the reactor over 30 min, Then MP 200 (6.94 g) and CP 450 (107 g) were added into the reactor over 10 min separately, and ADH (25.38 g in 50 g DI water) was added into the reactor at the end before filtering the resulting emulsion. Then, the obtained emulsion was filtered to determine the amount of coagulum formed in the polymerization process, according to the Wet Coagulum Content Test described above.

TABLE 2
Monomer Compositions for preparing polymer dispersions

| | Monomer composition, % by weight based on the total weight of monomers | | | | | | | | | |
|---|---|---|---|---|---|---|---|---|---|---|
| Polymer | for preparing each polymer dispersion | | | | | | | | | |
| Dispersion | DBI | MAA | DEI | MMA | EA | LMA 1214F | C₁₈MA | DAAM | AAEM | SSS |
| CE 1 | 30 | 1 | 0 | 10 | 55.5 | 0 | | | 3 | 0.5 |
| CE 2 | 0 | 1 | 25 | 0 | 60.5 | 10 | | | 3 | 0.5 |
| CE 3 | 30 | 1 | 0 | 14 | 49.5 | 5 | | | 0 | 0.5 |
| CE 4 | 30 | 1 | 0 | 10 | 45.5 | 5 | | | 8 | 0.5 |
| CE 5 | 30 | 1 | | 13 | 47.5 | 0 | 5 | | 3 | 0.5 |
| CE 6 | 23.5 | 1 | | 15 | 47 | 10 | | | 3 | 0.5 |
| CE 7 | 30 | 1 | | 13 | 22.5 | 30 | | | 3 | 0.5 |
| CE 8 | 0 | 1 | | 20 | 55.5 | 20 | | | 3 | 0.5 |
| CE 9 | 50 | 1 | 0 | 13 | 22.5 | 10 | | | 3 | 0.5 |
| CE 10 | 30 | 1 | 0 | 13 | 47.5 | 5 | | 3 | | 0.5 |
| IE 1 | 30 | 1 | 0 | 13 | 47.5 | 5 | | | 3 | 0.5 |
| IE 2 | 30 | 1 | 0 | 15 | 40.5 | 10 | | | 3 | 0.5 |
| IE 3 | 30 | 1 | 0 | 20 | 25.5 | 20 | | | 3 | 0.5 |
| IE 4 | 30 | 1 | 0 | 12.5 | 46 | 5 | | | 5 | 0.5 |
| IE 5 | 30 | 1 | 0 | 15 | 41.5 | 10 | | | 2 | 0.5 |
| IE 6 | 24.5 | 1 | | 15 | 46 | 10 | | | 3 | 0.5 |
| IE 7 | 30 | 1 | 0 | 13 | 48.5 | 4 | | | 3 | 0.5 |
| IE 8 | 35 | 1 | 0 | 14.5 | 41 | 5 | | | 3 | 0.5 |

TABLE 3
Properties of Polymer Dispersion

| Polymer | | Particle | Viscosity², | Solids | Calculated | Fox Tg⁵ | Wet coagulum |
|---|---|---|---|---|---|---|---|
| Dispersion | pH | size¹, nm | cps | content³, % | BCC⁴, % | (° C.) | content⁶ (ppm) |
| CE 1 | 9.37 | 181 | 116 | 51.99 | 54.04 | −2 | 85 |
| CE 2 | 9.37 | 131 | 166 | 50.82 | 45.89 | NA | 141 |
| CE 3 | 9.93 | 157 | 115 | 50.81 | 55.82 | −4 | 87 |
| CE 4 | 8.63 | 164 | 113 | 51.63 | 54.63 | −6 | 37 |
| CE 5 | 8.72 | 165 | 163 | 52.02 | 50.06 | NA | 62 |
| CE 6 | 8.7 | 163 | 145 | 52.78 | 52.86 | −9 | NA |
| CE 7 | 9.13 | 123 | 256 | 51.29 | 65.32 | −26 | 14 |
| CE 8 | 9.16 | 164 | 150 | 51.25 | 42.15 | −20 | 42 |
| CE 9 | 8.73 | 163 | 153 | 52.64 | 68.86 | −2 | 28 |
| CE 10 | 8.34 | 172 | 113 | 50.56 | 54.93 | NA | 55 |
| IE 1 | 9.3 | 164 | 110 | 51.43 | 55.18 | −4 | 42 |
| IE 2 | 9.36 | 156 | 139 | 51.52 | 56.65 | −7 | 127 |
| IE 3 | 9.34 | 133 | 287 | 51.9 | 59.01 | −11 | 127 |
| IE 4 | 8.92 | 168 | 121 | 51.26 | 54.69 | −4 | 275 |
| IE 5 | 9.04 | 156 | 122 | 51.33 | 56.98 | −7 | 98 |
| IE 6 | 9.14 | 173 | 116 | 52.73 | 53.45 | −8 | 110 |
| IE 7 | 9.02 | 175 | 116 | 51.82 | 54.72 | −3 | 3 |
| IE 8 | 9.11 | 159 | 120 | 51.84 | 57.57 | −1 | 14 |

¹Particle size was measured using a Brookhaven BI-90 Plus Particle Size Analyzer.
²Viscosity of a dispersion was tested using Brookfield Viscometer with spindle 2# at 60 rpm, in centipoises (cps).
³Solids content was measured by weighting 0.7 ± 0.1 g of a sample (wet weight of the sample is denoted as “W1”), putting the sample into an aluminum pan (weight of aluminum pan is denoted as “W2”) in an oven at 150° C. for 25 min, and then cooling and weighting the aluminum pan with the dried sample with total weight denoted as “W3”. “W3-W2” refers to dry or solids weight of the sample. Solids content is calculated by (W3-W2)/W1*100%.
⁴Calculated BCC was determined according to the Biobased Carbon Content Calculated Method described above.
⁵Fox Tg was calculated by the Fox equation described above.
⁶Wet coagulum content was measured according to the Wet Coagulum Content Test described above.

### Coating Compositions

The as prepared polymer dispersion of CE 1 was used as a latex binder for preparing the coating composition of Comp Paint A, based on formulations given in Table 4. Ingredients in the grind stage were mixed using a high speed Cowles disperser at a speed of 1,000 revolutions per minute (rpm). Then ingredients in the letdown stage were added and mixed by a conventional agitator at a speed of 500 rpm.

Other coating compositions were prepared according to the same procedure as the preparation of Comp Paint A above, based on formulations given in Table 4 except for different binders and binder loadings. Depends on its solid content, each latex binder added in each coating composition was in an amount to keep the same concentration of a binder in each coating composition, by dry weight relative to the coating composition weight. The binder used in each coating composition is given in Table 5.

TABLE 4
Formulations of Comp Paint A

| Ingredient | Function | Chemical description | Commercial source | Amount, gram |
|---|---|---|---|---|
| Grind | | | | |
| Water | | | | 141.5 |
| Natrosol 250 HBR | Thickener | Cellulose ether | Aqualon | 2.0 |
| NaOH (15%) | Base | Sodium hydroxide | Sinopharm | 1.0 |
| | | | Chemical Reagent | |
| | | | Co., Ltd. | |
| TERGITOL ™ 15-S-40 | Surfactant | Alcohol Ethoxylates | The Dow Chemical | 2.0 |
| ACUSOL ™ 425N | Dispersant | Polyacid | Company | 8.75 |
| Nopco NXZ | Defoamer | Nonionic silicon oil | Nopoc | 1.0 |
| Ti-Pure R-706 | Pigment | Titanium dioxide | Chemours | 220.0 |
| Celite 499 | Extender | Celite | Imerys | 10.0 |
| CC-700 | Extender | Calcium carbonate | Guangfu Building | 100 |
| DB-80 | Extender | Clay | Materials Group | 100 |
| | | | (China) | |
| Letdown | | | | |
| Latex binder | CE 1 polymer | | | 318.6 |
| | dispersion | | | |
| ROPAQUE ™ ULTRA | Hiding additive | Opaque polymer | The Dow Chemical | 40.0 |
| E | | | Company | |
| Nopco NXZ | Defoamer | Nonionic silicon oil | Nopoc | 2.0 |
| Acrysol ™ TT-935 | Thickener | Associative rheology modifier | The Dow Chemical | 8.5 |
| (50%) | | | Company | |
| NaOH (15%) | Neutralizer | | Sinopharm | 4 |
| | | | Chemical Reagent | |
| | | | Co., Ltd. | |
| ZPT38 | Biocide | Zinc pyrithione | Troy Corporation | 3.0 |
| KATHON ™ LX 1.5% | Biocide | 2-methyl-4-isothiazolin-3-one | LANXESS | 1.05 |
| | | (MIT) | | |
| ROCIMA ™ BT NV2 | Biocide | 1,2-benzisothiazolin-3-one (BIT) | | 0.5 |
| Water | | | | 36.1 |

Properties of the resultant coating compositions were evaluated according to the test methods described above and results are given in Table 5. The coating compositions of Paints 1 to 8 comprising the polymer dispersions of IE 1 through IE 8, respectively, all have a VOC content of less than 5 g/L, as measured according to GB18582-2008.

As shown in Table 5, all the inventive emulsion polymers (IE 1 through IE 8) each having a high biobased carbon content of at least 50% provided coating compositions and coatings that met all the requirements for the following properties: F/T stability (no visible coagulation or gel, and delta KU≤10), peel-off resistance (“P”), scrub resistance (>80% vs. Comp Paint A), early chalking resistance (≤3), and water whitening (ΔL<7).

In contrast, the coating compositions of Comp Paints A-K failed to meet one or more of the above required properties. CE 1 emulsion polymer prepared in the absence of LMA 1214F failed the peel-off resistance test. CE 2 emulsion polymer prepared by replacing DBI with DEI also provided poor peel-off resistance. CE 3 emulsion polymer that was prepared in the absence of AAEM provided poor peel-off resistance and water whitening resistance. CE 4 emulsion polymer prepared from monomers containing 8% of AAEM failed the F/T stability test and also provided poor early chalking resistance. CE 5 emulsion polymer prepared by replacing LMA 1214F with C₁₈MA failed to meet both requirements for F/T stability and water whitening resistance. Emulsion polymers prepared by using 23.5% of DBI and 75% of MAA, EA, LMA 1214F, and AAEM in total (CE 6) or using 50% of DBI and 48.5% of MAA, EA, LMA 1214F, and AAEM in total (CE 9) both provided poor water whitening resistance. CE 7 emulsion polymer with a high content of LMA 1214F (30%) resulted in reduced scrub resistance down to 80%. CE 8 emulsion polymer with 20% of LMA 1214F but no DBI and provided poor early chalking resistance. CE 10 emulsion polymer using DAAM (a different crosslinking monomer other than AAEM) resulted in poor F/T stability of coating composition (Comp Paint K). All percentages for monomers herein are weight percentages relative to the total weight of monomers.

TABLE 5
Properties of Coating Compositions and Coatings

| | Binder in | Properties | | | | |
|---|---|---|---|---|---|---|
| Coating | coating | F/T stability | Peel-off | Scrub | Early chalking | Water whitening |
| compositions | composition | (delta KU) | resistance test | resistance | resistance | resistance (ΔL) |
| Comp Paint A | CE 1 | 2.3 | Fail | 100% | 3 | 5.5 |
| Comp Paint B | CE 2 | NA | Fail | 109% | 3 | 4.11 |
| Comp Paint C | CE 3 | 1.9 | Fail | 108% | 2 | 20.24 |
| Comp Paint D | CE 4 | 15.1 | Pass | 95% | 4 | 0.93 |
| Comp Paint E | CE 5 | 15.4 | NA | NA | 2.5 | 36.2 |
| Comp Paint F | CE 6 | NA | NA | NA | NA | 28.8 |
| Comp Paint G | CE 7 | 2.3 | Pass | 80% | NA | NA |
| Comp Paint H | CE 8 | NA | NA | 177% | 3.5 | 1.9 |
| Comp Paint I | CE 9 | 0.7 | Pass | 117% | 3 | 7.98 |
| Comp Paint K | CE 10 | >40 | Pass | 262% | 2 | 1.72 |
| Paint 1 | IE 1 | 1.7 | Pass | 115% | 3 | 0.37 |
| Paint 2 | IE 2 | −0.2 | Pass | 142% | 2 | 0.74 |
| Paint 3 | IE 3 | 0.8 | Pass | 144% | 1 | 2.38 |
| Paint 4 | IE 4 | 2.6 | Pass | 100% | 3 | 2.75 |
| Paint 5 | IE 5 | −0.3 | Pass | 100% | 3 | 2.75 |
| Paint 6 | IE 6 | 5.4 | Pass | 114% | 3 | 6.8 |
| Paint 7 | IE 7 | 2.5 | Pass | 98% | 2.3 | 3.14 |
| Paint 8 | IE 8 | 3.7 | Pass | 106% | 3 | 3.4 |

1. An aqueous dispersion comprising an emulsion polymer, wherein the emulsion polymer comprises, by weight based on the weight of the emulsion polymer,
(i) from 24.5% to 35% of structural units of monomer (a) having a biobased carbon content of 92% or more and having the structure of formula (I): 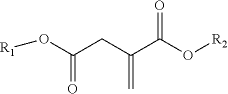
where R₁ and R₂ are each independently selected from an alkyl group having from 4 to 10 carbon atoms;
(ii) from 0.1% to 10% of structural units of monomer (b) an ethylenically unsaturated carrying at least one functional group selected from carboxyl, carboxylic anhydride, sulfonic acid, sulphonate, hydroxyl, amide, or combinations thereof; salts thereof; or mixtures thereof;
(iii) from 20% to 50% of structural units of monomer (c) ethyl (meth)acrylate that has a biobased carbon content of 30% to 60%;
(iv) from 4% to 20% of structural units of monomer (d) an alkyl (meth)acrylate that has a linear alky group with 8 to 16 carbon atoms and that has a biobased carbon content of 60% or more;
(v) from 1.5% to 7% of structural units of monomer (e) an acetoacetoxy or acetoacetamide functional monomer;
(vi) from 5% to 25% structural units of monomer (f) a hard monomer; and
(vii) from zero to 15% of structural units of monomer (g) an additional ethylenically unsaturated nonionic monomer;
wherein the total concentration of structural units of monomers (c), (d), (e), and (f) is in a range of 51% to 74%; and
wherein the emulsion polymer particles have a particle size of 60 nanometers to 300 nanometers.

2. The aqueous dispersion of claim 1, wherein monomer (a) of formula (I) is dibutyl itaconate.

3. The aqueous dispersion of claim 1, further comprising an epoxy functional silane, a polyoxypropylene polyol having a number average molecular weight of 350 to 3500, or mixtures thereof.

4. The aqueous dispersion of claim 1, wherein monomer (d) is n-octyl (meth)acrylate, n-decyl (meth)acrylate, lauryl (meth)acrylate, tetradecyl (meth)acrylate, hexadecyl (meth)acrylate, or a mixture thereof.

5. The aqueous dispersion of claim 1, wherein the acetoacetoxy or acetoacetamide functional monomer is acetoacetoxyethyl methacrylate, acetoacetoxyethyl acrylate, or a mixture thereof.

6. The aqueous dispersion of claim 1, wherein the hard monomer is methyl methacrylate.

7. The aqueous dispersion of claim 1, wherein the emulsion polymer has a glass transition temperature of −40° C. to 40° C. as determined by the Fox equation.

8. The aqueous dispersion of claim 1, wherein the emulsion polymer comprises, by weight based on the weight of the emulsion polymer,
from 24.5% to 35% of structural units of dibutyl itaconate;
from 25.5% to 48.5% of structural units of ethyl acrylate;
from 0.5% to 5% of structural units of (meth)acrylic acid, sodium styrene sulfonate, 2-acrylamido-2-methylpropanesulfonic acid, or mixtures thereof;
from 4% to 20% of structural units of lauryl methacrylate, tetradecyl methacrylate, hexadecyl methacrylate, or mixtures thereof;
from 2% to 5% of structural units of acetoacetoxyethyl methacrylate;
from 5% to 20% of structural units of the hard monomer; and
from zero to 5% of structural units of the additional ethylenically unsaturated nonionic monomer.

9. The aqueous dispersion of claim 1, wherein the emulsion polymer is a multistage polymer comprising a polymer A and a polymer B, wherein the polymer A comprises, by weight based on the weight of the polymer A, from zero to less than 0.1% of structural units of monomer (e); and the polymer B comprises, by weight based on the weight of the polymer B, from 3.5% to 10% of structural units of monomer (e).

10. A method of preparing the aqueous dispersion of claim 1, comprising emulsion polymerization of monomers comprising monomers (a) to (g).

11. A coating composition comprising the aqueous dispersion of claim 1.
